(19) United States
(12) Patent Application Publication
(10) Pub. No.: US 2026/0350087 A1
(43) Pub. Date: Nov. 5, 2026

(54) Query Formulation Model Training and Inference for Gesture Input Understanding

(71) Applicant: Google LLC, Mountain View, CA (US)

(72) Inventors: Nils Grimsmo, Wollerau (CH); Clement Dickinson Wright, Los Angeles, CA (US); Yannick André Strümpler, Zurich (CH); Raphaela Güntensperger, Zurich (CH)

(21) Appl. No.: 19/196,254

(22) Filed: May 1, 2025

(51) Int. Cl. G06F 16/532; G06F 3/01; G06F 16/51; G06F 16/58

(52) U.S. Cl. CPC G06F 16/532; G06F 3/017; G06F 16/51; G06F 16/5866

(57) ABSTRACT

Systems and methods for image-gesture pair processing can include obtaining image data and a gesture input, processing the image-gesture pair with a query formulation model to generate an intermediate output, and transmitting the intermediate output and the image data to the downstream system to condition the downstream system to provide additional weighting to a determined region of interest. The query formulation model can be trained on logged interaction data associated with region-of-interest corrections and click data logs.

### FIELD

The present disclosure relates generally to training and utilizing a query formulation model for processing an image input and a gesture input associated with the image input. More particularly, the present disclosure relates to training a query formulation model on logged interaction data and utilizing the query formulation model to generate an intermediate output based on an image-gesture input pair in which the intermediate output can condition downstream image processing.

### BACKGROUND

Understanding the world at large can be difficult. Whether an individual is trying to understand what the object in front of them is, trying to determine where else the object can be found, and/or trying to determine where an image on the internet was captured from, text searching alone can be difficult. In particular, users may struggle to determine which words to use. Additionally, the words may not be descriptive enough and/or abundant enough to generate desired results.

Gesture processing can be difficult based on the complexities of understanding the position, size, and/or shape of a selected region. Additionally, image segmentation may be utilized in a gesture processing pipeline, which may be problematic if the correct region was not determined. Moreover, segmentation may be problematic in some instances in which full image context is beneficial.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include obtaining, by a computing system including one or more processors, image data including one or more images descriptive of an environment. The method can include obtaining, by the computing system, one or more gesture inputs. The one or more gesture inputs can include one or more attributes. The one or more attributes can include one or more shapes, one or more sizes, and one or more positions associated with features within the one or more images. The method can include processing, by the computing system, the image data and the one or more gesture inputs with a query formulation model to generate one or more intermediate outputs. The one or more intermediate outputs can be descriptive of one or more regions determined to be associated with the one or more gesture inputs. The one or more intermediate outputs can be determined based on the features within the one or more images and the one or more attributes of the gesture inputs. The method can include providing, by the computing system and within an interactive user interface, one or more region-of-interest visualizations of the one or more intermediate outputs overlaid over the one or more images. The method can include obtaining, by the computing system, one or more correction inputs descriptive of one or more augmentations to the one or more region-of-interest visualizations. The method can include evaluating, by the computing system, one or more loss functions based on the one or more gesture inputs, the one or more intermediate outputs, and the one or more correction inputs and adjusting, by the computing system, one or more parameters of the query formulation model based on the one or more loss functions.

In some implementations, the method can include processing, by the computing system, the one or more images and the one or more intermediate outputs with an embedding model to generate one or more gesture-aware embeddings and determining, by the computing system, one or more search results based on the gesture-aware embeddings. The method can include processing, by the computing system, the one or more images, the one or more intermediate outputs, and the one or more search results with a generative model to generate one or more model-generated responses to the query. In some implementations, the generative model can include a vision language model. The one or more model-generated responses can include a plurality of predictions grounded based on information of the one or more search results. The one or more model-generated responses can include one or more multimodal responses to the query.

In some implementations, the method can include providing, by the computing system, the one or more search results for display in a search results interface; obtaining, by the computing system, a user selection of a particular search result of the one or more search results; and storing, by the computing system, log data in an interaction log. The log data can include the one or more images, the one or more gesture inputs, the one or more intermediate outputs, the one or more search results, and data descriptive of the user selection. The method can include adjusting, by the computing system, the one or more parameters of the query formulation model based on the log data.

In some implementations, the one or more gesture inputs can include one or more irregular shapes. The one or more intermediate outputs can include a plurality of pixel-based positional values descriptive of one or more boundaries of one or more regions of interest. The one or more intermediate outputs can include one or more attention maps.

Another example aspect of the present disclosure is directed to a computing system for query formulation model training. The system can include one or more processors and one or more non-transitory computer-readable media that collectively store instructions that, when executed by the one or more processors, cause the computing system to perform operations. The operations can include obtaining image data including one or more images descriptive of an environment. The operations can include obtaining one or more gesture inputs. The one or more gesture inputs can include one or more attributes. The one or more attributes can include one or more shapes, one or more sizes, and one or more positions associated with features within the one or more images. The operations can include processing the image data and the one or more gesture inputs with a query formulation model to generate one or more intermediate outputs. The one or more intermediate outputs can be descriptive of one or more regions determined to be associated with the one or more gesture inputs. The one or more intermediate outputs can be determined based on the features within the one or more images and the one or more attributes of the gesture inputs. The operations can include processing the one or more images and the one or more intermediate outputs with an embedding model to generate one or more gesture-aware embeddings. The operations can include determining a plurality of search results based on the gesture-aware embeddings and providing the plurality of search results for display in a search results interface. The operations can include obtaining a user selection of a particular search result of the plurality of search results and storing log data in an interaction log. The log data can include the one or more images, the one or more gesture inputs, the one or more intermediate outputs, the one or more search results, and data descriptive of the user selection. The operations can include adjusting one or more parameters of the query formulation model based on the log data.

In some implementations, the operations can include providing, within an interactive user interface, one or more region-of-interest visualizations of the one or more intermediate outputs overlaid over the one or more images; obtaining one or more correction inputs descriptive of one or more augmentations to the one or more region-of-interest visualizations; evaluating one or more loss functions based on the one or more gesture inputs, the one or more intermediate outputs, and the one or more correction inputs; and adjusting the one or more parameters of the query formulation model based on the one or more loss functions.

In some implementations, the query formulation model can be further trained on one or more pseudo labels generated with a generative language model. The one or more pseudo labels can be generated by: obtaining one or more multimodal queries; processing the one or more multimodal queries with a generative language model to determine one or more requested tasks; generating, with the generative language model, one or more model-generated queries based on the one or more multimodal queries and the one or more requested tasks; and storing the one or more model-generated queries as the one or more pseudo labels. In some implementations, training with the one or more pseudo labels can include: generating one or more refined queries based on the one or more images and the one or more intermediate outputs; and adjusting the one or more parameters of the query formulation model based on a comparison between the one or more pseudo labels and the one or more refined queries.

In some implementations, the query formulation model can include a generative model trained on chain-of-thought reasoning training examples.

Another example aspect of the present disclosure is directed to one or more non-transitory computer-readable media that collectively store instructions that, when executed by one or more computing devices, cause the one or more computing devices to perform operations. The operations can include obtaining image data including one or more images descriptive of an environment. The operations can include obtaining one or more gesture inputs. The one or more gesture inputs can include one or more attributes. The one or more attributes can include one or more shapes, one or more sizes, and one or more positions associated with features within the one or more images. The operations can include processing the image data and the one or more gesture inputs with a query formulation model to generate one or more intermediate outputs. The one or more intermediate outputs can be descriptive of one or more regions determined to be associated with the one or more gesture inputs. The one or more intermediate outputs can be determined based on the features within the one or more images and the one or more attributes of the gesture inputs. The operations can include determining a plurality of search results based on the one or more images and the one or more intermediate outputs and processing the one or more images and the one or more intermediate outputs with one or more classification models to generate one or more task classifications. The operations can include processing the one or more images, the one or more intermediate outputs, and the one or more task classifications with a generative vision language model to generate a model-generated response and providing the plurality of search results and the one or more model-generated responses for display in a search results interface.

In some implementations, the query formulation model may have been trained on log data from one or more interaction logs. The one or more interaction logs can include a plurality of training examples. One or more of the plurality of training examples can include one or more logged images, one or more logged gesture inputs, one or more logged intermediate outputs descriptive of one or more regions determined to be associated with the one or more logged gesture inputs, and one or more logged correction inputs descriptive of one or more user corrections to the one or more logged intermediate outputs. In some implementations, one or more of the plurality of training examples can include one or more logged images, one or more logged gesture inputs, one or more logged intermediate outputs descriptive of one or more regions determined to be associated with the one or more logged gesture inputs, one or more logged search results responsive to one or more queries including the one or more logged images and the one or more logged intermediate outputs, and one or more logged user selections of one or more of the one or more logged search results.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example query formulation model training system according to example embodiments of the present disclosure.

FIG. 2 depicts a block diagram of an example image-gesture query processing system according to example embodiments of the present disclosure.

FIG. 3 depicts a flow chart diagram of an example method to perform query formulation model training according to example embodiments of the present disclosure.

FIG. 4 depicts an illustration of example image-gesture pairs according to example embodiments of the present disclosure.

FIG. 5 depicts an illustration of an example snap-to interface according to example embodiments of the present disclosure.

FIG. 6 depicts illustrations of example search instances according to example embodiments of the present disclosure.

FIG. 7 depicts a flow chart diagram of an example method to perform click data-based training according to example embodiments of the present disclosure.

FIG. 8 depicts a flow chart diagram of an example method to perform query formulation model inference-based search according to example embodiments of the present disclosure.

FIG. 9 depicts a block diagram of an example search system according to example embodiments of the present disclosure.

FIG. 10A depicts a block diagram of an example computing system that performs query formulation model training and inference according to example embodiments of the present disclosure.

FIG. 10B depicts a block diagram of an example computing system that performs query formulation model training and inference according to example embodiments of the present disclosure.

Reference numerals that are repeated across plural figures are intended to identify the same features in various implementations.

### DETAILED DESCRIPTION

Generally, the present disclosure is directed to training a query formulation model and utilizing a query formulation model for model inference. In particular, the systems and methods disclosed herein can leverage a query formulation model to process image data and a gesture input to generate an intermediate output that can then be processed with a search system to determine search results. For example, the systems and methods can include obtaining a gesture input selecting at least a portion of an input image (e.g., an image query) and processing the input image and the gesture input with a query formulation model to generate an intermediate output descriptive of a determination of the features of the input image being selected by the gesture input. The intermediate output and the input image can then be processed with a search engine and/or a generative model to determine search results and/or generate a model-generated response that is conditioned based on the intermediate output. The query formulation model can be trained on logged interaction data.

The training can include collecting interaction data and then adjusting parameters of the query formulation model based on the interaction data. For example, the intermediate outputs can be descriptive of a region-of-interest determined based on the gesture input. A visualization of the region-of-interest indicated by the intermediate output can be generated and provided for display over the input image. The system can receive a correction input from a user computing device. The correction input can be descriptive of a correction to the region. The correction input can be processed and utilized to update parameters of the query formulation model.

The systems and methods disclosed herein can be utilized to train a query formulation model to understand different gestures. The gestures may be irregular in shape, may include encapsulation selections, may include outline selections, and/or may include a plurality of taps. The gesture understanding may be performed based on training the query formulation model to determine regions-of-interest past mere snap-to region rectangles. In some implementations, the query formulation model can be trained to generate irregular shaped regions-of-interest identifications, which can lead to irregular shaped attention maps and/or fuzzy representations that may not be rectangles or other symmetrical and regular shapes.

Additionally and/or alternatively, the intermediate output and the input image may be embedded and utilized to determine a plurality of search results. The search results interface may display at least a subset of the search results and may receive a selection of a particular search result. The click data may be stored and utilized to update parameters of the query formulation model. Additional and/or alternative training techniques may include training on large language model outputs, tuning on user search histories, performing user-specific personalization, and/or other training techniques.

Query formulation model training can be utilized to train a machine-learned model to understand a region of an image that is being selected by a gesture input. The gesture input may be obtained to contextualize an input image query and/or may be obtained with an overlay interface of a user computing device to invoke a visual search of displayed content. The systems and methods disclosed herein can be utilized to train and/or utilize query formulation models to generate intermediate outputs that can be utilized to condition a search engine and/or generative model predictions.

Existing gesture processing systems may merely receive a gesture and output a bounding box based on the position (and in some instances the size) of the gesture. The existing gesture processing systems fail to adjust for different gesture shapes and/or other contexts.

Moreover, the existing gesture processing systems may generate image segments that are then searched without providing the full image context, which may lead to irrelevant search results and/or inaccurate model outputs.

The query formulation model can be trained to generate intermediate outputs (or attention outputs that may be utilized as attention maps for conditioning image processing) based on processing a query image and a gesture input. The intermediate output can be descriptive of a region of interest and may be transmitted downstream along with the full query image to condition the search and/or model inference. The training can include training the model on user feedback via adjusting parameters based on region corrections and/or search result click data.

The utilization of the intermediate output can allow the search engine and/or generative model to process the full input image, while still being conditioned to focus on a particular region, which can allow for full image context understanding and gesture-context.

Query formulation models that output attention maps instead of image segments can provide for full-image context, while still providing region-of-interest conditioning for search tasks. The model training can be utilized to train the model to generate more gesture-aware bounding regions as previous implementations merely snapped to a region associated with a polygon mask generated based on a positioning of a gesture. The use of the intermediate output in place of performing image segmentation can afford for full image context understanding, while still conditioning the processing on the gesture understanding.

In some implementations, the query formulation model may be trained on pseudo labels generated with a generative model (e.g., a large language model, which may include a large vision language model). For example, a generative model can process the image to generate a plurality of object labels. Additionally and/or alternatively, the generative model may process the image and a gesture input to generate a predicted region of interest. A pseudo label can be generated based on the predicted region of interest. The image and the gesture input can be processed with the query formulation model to generate an intermediate output that includes a fuzzy representation associated with a region-of-interest. The parameters of the query formulation model can then be tuned based on comparing the pseudo label to the fuzzy representation.

The systems and methods of the present disclosure provide a number of technical effects and benefits. As one example, the system and methods can determine a region-of-interest based on processing a gesture input and an input image. The region-of-interest determination can be utilized to generate an intermediate output that can condition the search engine and/or a generative model to focus on one or more particular regions of the input image. The intermediate output can include an attention map that identifies the region-of-interests via providing attention values and/or weights to the downstream search engine and/or generative model. By utilizing an intermediate output and the full input image, the search engine and/or generative model can receive the full image context while still weighting the region-of-interest more heavily, which may provide benefits in some instances over an image segmentation alternative.

Another example of technical effect and benefit relates to improved computational efficiency and improvements in the functioning of a computing system. For example, the systems and methods disclosed herein can leverage the intermediate output generation to avoid the computational cost of image segmentation, while also reducing the search computational cost by improving search result outputs and mitigating follow-up search instances.

The systems and methods of the present disclosure provide a number of technical effects and benefits. As one example, the system and methods can determine an action to perform based on classifying an obtained gesture input and determining a particular portion of the displayed content item to perform the action on based on a position and/or size of the gesture input. The systems and methods can leverage gesture mask generation and processing to determine what content to segment and process. The gesture input can be classified to determine the gesture type, which can then be utilized to determine which data processing action to perform. By leveraging gesture masks and gesture classification, the systems and methods can perform content segmentation and action selection without relying on a plurality of different inputs, tedious selections, and/or navigating to a plurality of different applications. Moreover, the systems and methods can be implemented at the operating system level of a computing device to provide the action capabilities across a plurality of different applications without the computational cost and/or tedious inputs of traditional techniques.

Another technical benefit of the systems and methods of the present disclosure is the ability to leverage the system to generate and store content snippets. In particular, the systems and methods disclosed herein can obtain input data, determine a content item (e.g., text, image, video, and/or audio) associated with the input data, generate a content snippet, and store the content snippet. The content snippet can include a graphical representation (e.g., an image (e.g., a bitmap)) of the selected content that when selected can direct the user to a portion of a web page and/or a location within an application that the selected content originates from. The content snippet generation and saving can enable easy access to saved content while maintaining a link and/or other details associated with a context for the content item.

Another technical benefit of the systems and methods of the present disclosure is the ability to leverage the content snippet to share layered levels of information with relatively little transmission cost. For example, the systems and methods can generate a content snippet. The content snippet can be shared with a second user, who can initially view the graphical representation (e.g., the visual data). The second user can then select the graphical representation of the content snippet to navigate to a web page (and/or application) and be routed to the particular portion of the web page (and/or application) the content item originates from, which can allow the second user to obtain more context on the isolated content. The providing of layered information can be completed with relatively low transmission cost as the content item, the source data, and/or other context data may be transmitted. The second user can interact with the content snippet, view the content item in isolation, can then select the content snippet to use the source data and/or other context data to navigate to a portion of the web page (and/or source application) with the content item highlighted or otherwise indicated. Sending the whole web page file with highlighting may include much more upload and download during transmission.

Another technical benefit of the systems and methods of the present disclosure is the ability to leverage a generative model to categorize selected content of a content snippet, determine related content snippets, label content snippets, and/or determine when to surface the content snippets. Additionally and/or alternatively, the generative model may process the content snippet to determine and/or facilitate the searching of suggested content items to provide to the user. The generative model can identify semantic relationships, which may be utilized for determining user interests, similar content snippets/content items, and/or suggested searches.

The systems and methods disclosed herein can be leveraged to better disambiguate and/or understand the object and/or entity of focus. In particular, the entity may then be highlighted/selected, possibly annotated, and/or stored. In some implementations, the systems and methods can include utilizing a generative model (e.g., a large language model (LLM)) to help auto organize these stored ideas.

Another example of technical effect and benefit relates to improved computational efficiency and improvements in the functioning of a computing system. For example, the systems and methods disclosed herein can leverage the content snippet to mitigate the amount of data stored in order to save sub-portions of content of interest to the user with relevant context data. In particular, the content snippet may include a compressed version of the isolated content item, source information, and/or other context data in place of saving a compressed version of the full web page and/or application thread, which may include a large quantity of content items and embedded data. Additionally, searching through a collection of content snippets can be computationally less expensive than searching through a plurality of compressed web pages.

With reference now to the Figures, example embodiments of the present disclosure will be discussed in further detail.

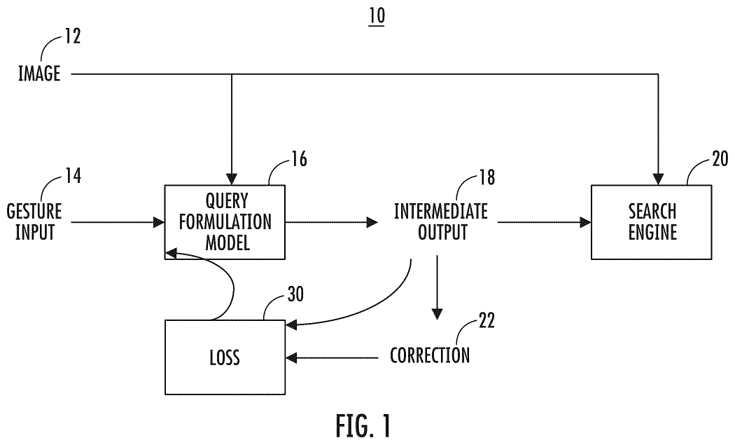

FIG. 1 depicts a block diagram of an example query formulation model training system 10 according to example embodiments of the present disclosure. In some implementations, the query formulation model training system 10 is configured to receive, and/or obtain, an image 12 descriptive of an environment and/or screen capture and, as a result of receipt of the image 12 and a gesture input 14, generate, determine, and/or provide an intermediate output 18 that can evaluated based on a loss 30 that evaluates the intermediate output 18 in relation to a correction 22. Thus, in some implementations, the query formulation model training system 10 can include a query formulation model 16 that is operable to generate an intermediate output 18 that can then be transmitted to a search engine 20 with the image 12 to perform a search.

In particular, the query formulation model training system 10 can obtain an image 12 descriptive of an environment and/or a screen capture of a user computing device. The screen capture may be obtained via an overlay interface that dynamically captures and processes display data for search across different applications, web pages, and/or other digital surfaces.

The query formulation model training system 10 can obtain a gesture input 14 that selects one or more portions of the image 12. The gesture input 14 can include a circle, a scribble, a rectangle, interconnected shapes, irregular shapes, and/or other freeform inputs. The gesture input 14 may encapsulate a selected portion, may outline an object of interest, and/or other form of selection.

The image 12 and the gesture input 14 can be processed with a query formulation model 16 to generate an intermediate output 18. The query formulation model 16 can include identifying a plurality of objects and/or other feature sets within the image 12 and can determine which feature sets are associated with the gesture input 14 in order to determine a region-of-interest. The intermediate output 18 can include a fuzzy representation and/or attention map associated with one or more regions-of-interest. The image 12 and the intermediate output 18 can be transmitted to a search engine 20 and/or other downstream processing system to condition the search engine 20 and/or other downstream processing system to weigh the regions-of-interest more heavily during processing, while maintaining the full context of the full image 12.

The query formulation model training system 10 can provide a visual representation of the intermediate output 18 for display, which can be provided in an interface in which a user can provide corrections 22 to the regions-of-interest. Any received corrections 22 can then be utilized to evaluate a loss 30, which can then be utilized to adjust one or more parameters of the query formulation model 16. For example, the intermediate output 18 may be descriptive of a region-of-interest that has a first size, a first shape, and a first set of positions, and a corrected region-of-interest based on the corrections 22 may have a second size, a second shape, and a second set of positions. The one or more parameters of the query formulation model can be adjusted based on a comparison between the first size, the first shape, and the first set of positions and the second size, the second shape, and the second set of positions.

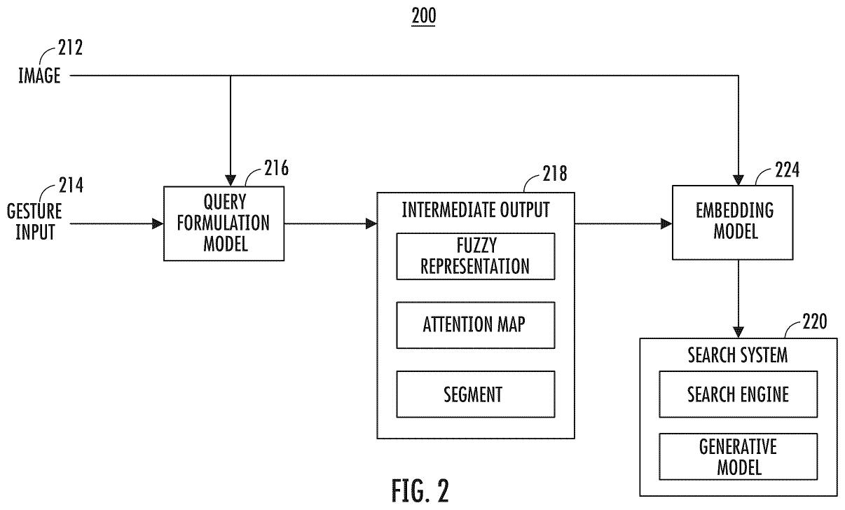

FIG. 2 depicts a block diagram of an example image-gesture query processing system 200 according to example embodiments of the present disclosure. The image-gesture query processing system 200 is similar to query formulation model training system 10 of FIG. 1 except that image-gesture query processing system 200 further includes an embedding model 224 to embed the image 212 and intermediate output 218 before search system 220 processing.

In particular, the image-gesture query processing system 200 can obtain an image 212 descriptive of an environment and/or a screen capture of a user computing device. The screen capture may be obtained via an overlay interface that dynamically captures and processes display data for search across different applications, web pages, and/or other digital surfaces. The image 212 may be obtained via one or more sensors of a smart wearable (e.g., image sensors of smart glasses).

The image-gesture query processing system 200 can obtain a gesture input 214 that selects one or more portions of the image 212. The gesture input 214 can include a circle, a scribble, a rectangle, interconnected shapes, irregular shapes, and/or other freeform inputs. The gesture input 214 may encapsulate a selected portion, may outline an object of interest, and/or other form of selection. The gesture input 214 may be obtained via identifying hand, finger, and/or eye movements with one or more image sensors of a user computing device (e.g., image sensors of smart glasses). The gesture input 214 may be obtained via an array of touch sensors of a user computing device. The image 212 and the gesture input 214 may be part of a query pair.

In some implementations, the query may further include a text string (e.g., a question associated with the image 212), a voice command, and/or other inputs.

The image 212 and the gesture input 214 can be processed with a query formulation model 216 to generate an intermediate output 218. The query formulation model 216 can identify a plurality of objects and/or other feature sets within the image 212 and can determine which feature sets are associated with the gesture input 214 in order to determine a region-of-interest.

The intermediate output 218 can include a fuzzy representation and/or attention map associated with one or more regions-of-interest. In some implementations, the intermediate output 218 may include an attention map (e.g., an array of pixel weight values that provide heavier weights to pixels associated with a determined region of interest). Alternatively and/or additionally, the intermediate output 218 may include and/or be utilized to generate one or more image segments descriptive of one or more regions-of-interest.

The image 212 and the intermediate output 218 can be embedded with an embedding model 224 to generate a gesture-aware embedding that is conditioned to emphasize vector feature values associated with the region-of-interest indicated by the intermediate output 218.

The gesture-aware embedding can then be transmitted to a search system 220 to perform a search and/or model inference. In some implementations, the query may further include an input text string, an input voice command, and/or a model-generated prompt (e.g., a prompt generated based on object detection and/or context determination). The input text string, the input voice command, and/or the model-generated prompt may be transmitted to the search system 220 and/or may be embedded within the gesture-aware embedding.

For example, the gesture-aware embedding may be processed with a search engine of the search system 220 to determine a plurality of search results. Additionally and/or alternatively, the gesture-aware embedding and/or at least a subset of the plurality of search results may be processed with a generative model (e.g., a vision language model) to generate a model-generated response to the image-gesture query pair. The search results and the model-generated response may then be provided for display within a search results interface.

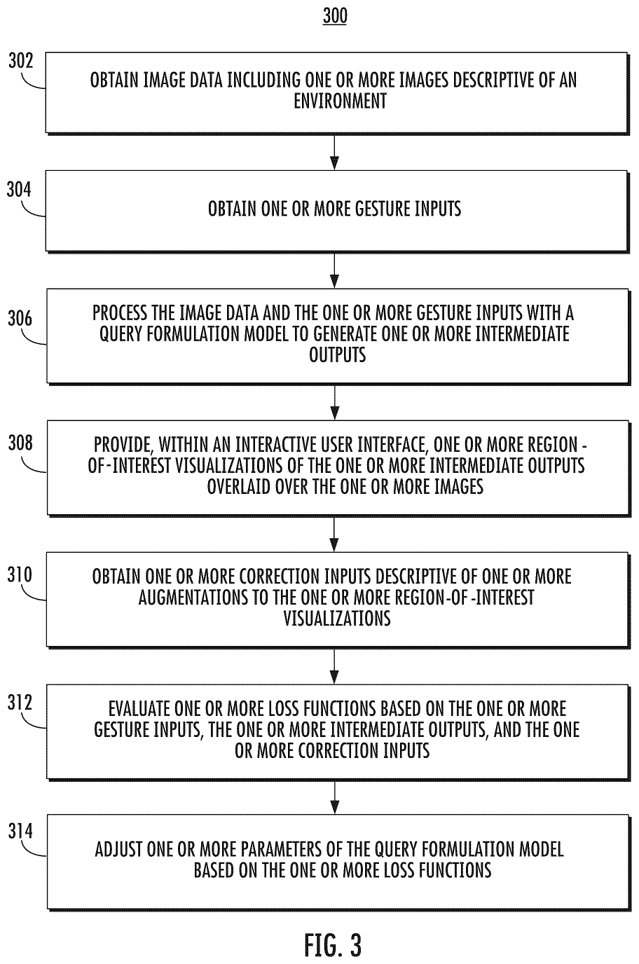

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain image data including one or more images descriptive of an environment. The image data can include the one or more images and image metadata. The environment can include a plurality of different features descriptive of a plurality of different objects. The one or more images may depict one or more screenshots of a user computing device. The image data may be generated with a mobile computing device, which may include a smart wearable (e.g., smart glasses).

At 304, the computing system can obtain one or more gesture inputs. The one or more gesture inputs can include one or more attributes. The one or more attributes can include one or more shapes, one or more sizes, and/or one or more positions associated with features within the one or more images. In some implementations, the one or more gesture inputs can include one or more irregular shapes. The one or more gesture inputs may be obtained via one or more sensors of a user computing device (e.g., sensors of a touchscreen). In some implementations, the one or more gesture inputs may be obtained via one or more sensors of a smart wearable (e.g., image sensors of smart glasses and/or touch sensors or motion sensors of a smart watch).

At 306, the computing system can process the image data and the one or more gesture inputs with a query formulation model to generate one or more intermediate outputs. The one or more intermediate outputs can be descriptive of one or more regions determined to be associated with the one or more gesture inputs. The one or more intermediate outputs can be determined based on the features within the one or more images and the one or more attributes of the gesture inputs. In some implementations, the one or more intermediate outputs can include a plurality of pixel-based positional values descriptive of one or more boundaries of one or more regions of interest. The one or more intermediate outputs can include one or more attention maps. In some implementations, the one or more intermediate outputs may include one or more fuzzy representations. The one or more fuzzy representations may include a silhouette of a shape similar to the shape of the gesture which is snapped to a set of features depicted in the one or more images.

At 308, the computing system can provide, within an interactive user interface, one or more region-of-interest visualizations of the one or more intermediate outputs overlaid over the one or more images. The one or more region-of-interest visualizations may include highlighting or tinting one or more regions. The one or more region-of-interest visualizations may include one or more indicators that depict a shape, size, and position of the region-of-interest. The shape may be a rectangle and/or may be a shape selected based on the shape of the one or more gesture inputs.

At 310, the computing system can obtain one or more correction inputs descriptive of one or more augmentations to the one or more region-of-interest visualizations. The one or more correction inputs may include size corrections, shape corrections, and/or position corrections. The one or more correction inputs may be received via the interactive user interface.

At 312, the computing system can evaluate one or more loss functions based on the one or more gesture inputs, the one or more intermediate outputs, and the one or more correction inputs. The one or more loss functions may include one or more penalization terms associated with one or more determined magnitudes of corrections. For example, the penalization may increase in relation to the severity of difference between the intermediate output region-of-interest and the corrected region-of-interest. The evaluation of the one or more loss functions may generate one or more gradient descents that can be backpropagated to the query formulation model.

At 314, the computing system can adjust one or more parameters of the query formulation model based on the one or more loss functions. The one or more parameters may be adjusted based on the one or more gradient descents. The adjustment may be part of initial model training, retraining, and/or fine-tuning. The query formulation model may be pre-trained via distillation learning from a larger model then fine-tuned on interaction data.

In some implementations, the computing system can process the one or more images and the one or more intermediate outputs with an embedding model to generate one or more gesture-aware embeddings and determine one or more search results based on the gesture-aware embeddings.

In some implementations, the computing system can process the one or more images, the one or more intermediate outputs, and the one or more search results with a generative model to generate one or more model-generated responses to the query. The generative model can include a vision language model. The one or more model-generated responses can include a plurality of predictions grounded based on information of the one or more search results. The one or more model-generated responses can include one or more multimodal responses to the query.

Alternatively and/or additionally, the computing system can provide the one or more search results for display in a search results interface, obtain a user selection of a particular search result of the one or more search results, and store log data in an interaction log. The log data can include the one or more images, the one or more gesture inputs, the one or more intermediate outputs, the one or more search results, and data descriptive of the user selection. The computing system can adjust the one or more parameters of the query formulation model based on the log data.

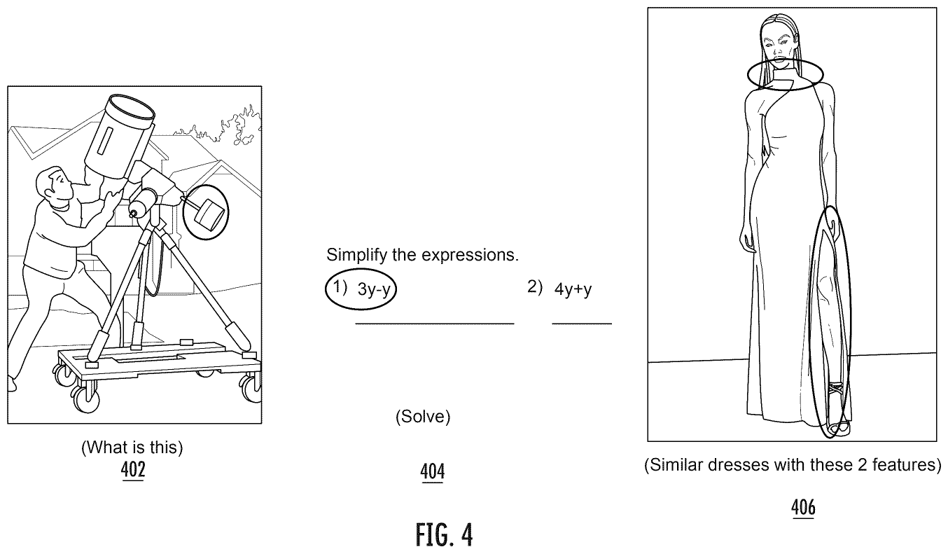

FIG. 4 depicts an illustration of example image-gesture pairs 400 according to example embodiments of the present disclosure. In particular, FIG. 4 depicts example image-gesture pairs 400 that may benefit from full image context. For example, the first image-gesture pair 402 depicts a gesture that encloses a portion of a larger object. Without the larger object details, identification and addressing the text string of the query may be difficult. The systems and methods disclosed herein can address the potential issue by allowing the full image to be transmitted, while conditioning the model and/or search engine based on a determined gesture understanding. The second image-gesture pair 404 depicts a gesture that selects a problem number; however the problem prompt may not be able to be determined without other image region context. The third image-gesture pair 406 depicts two gestures that enclose two portions of a dress. Without the larger object details, identification and addressing the task of the query may be difficult.

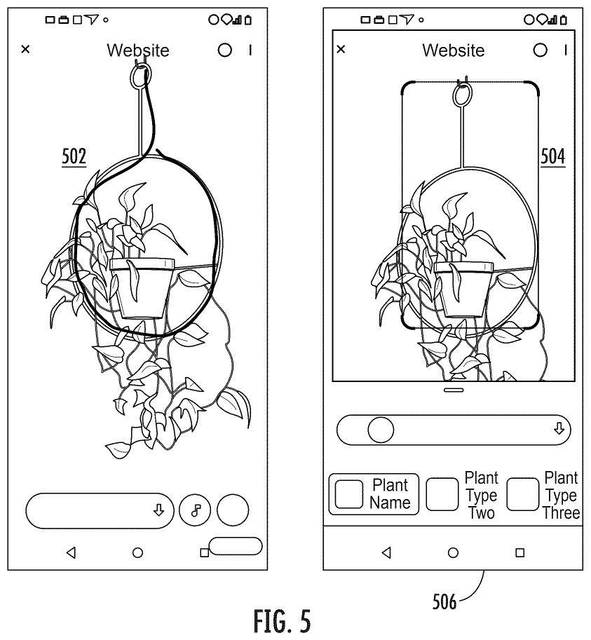

FIG. 5 depicts an illustration of an example snap-to interface 500 according to example embodiments of the present disclosure. In particular, FIG. 5 depicts an irregularly shaped gesture 502 that outlines an object of interest. Existing systems may fail to understand the gesture selection and may merely identify the plant within the circle as being the selected object. The systems and methods disclosed herein can be utilized to train a query formulation model to determine the object of interest is the planter that is being outlined by the gesture 502. The snap-to interface 500 may then provide a visualization of the intermediate output 504 via a rectangular indicator and/or may highlight the silhouette of the object of interest. The intermediate output and the image can then be searched to determine a plurality of search results that can then be provided for display in a swipe-up interface 506.

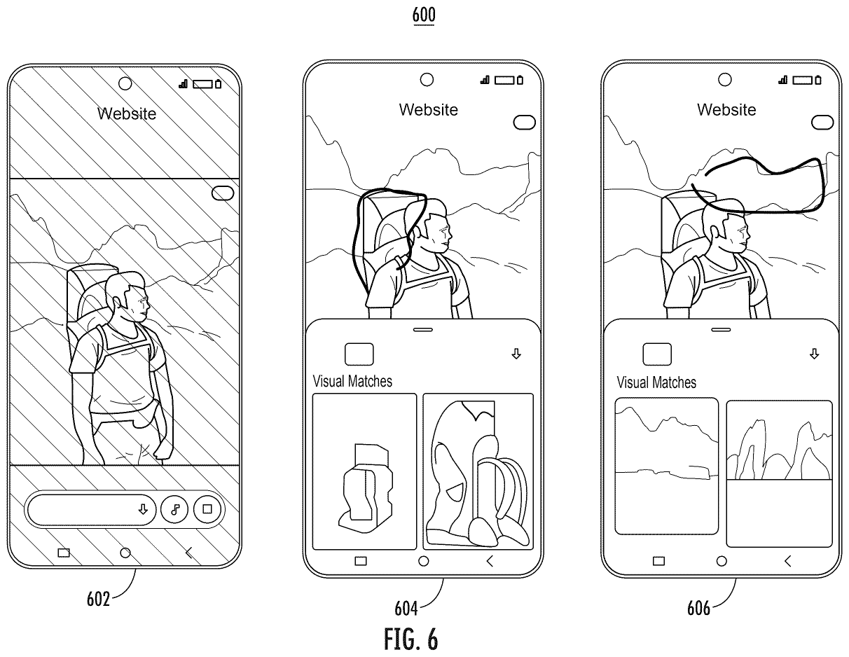

FIG. 6 depicts illustrations of example search instances 600 according to example embodiments of the present disclosure. In particular, FIG. 6 depicts an example interface flow of a search system that leverages a trained query formulation model. At 602, an overlay visual search interface may be invoked to search features within displayed content. At 604, a backpack may be selected and searched based on a first gesture input. At 606, a set of geographic structures may be selected and searched based on a second gesture input.

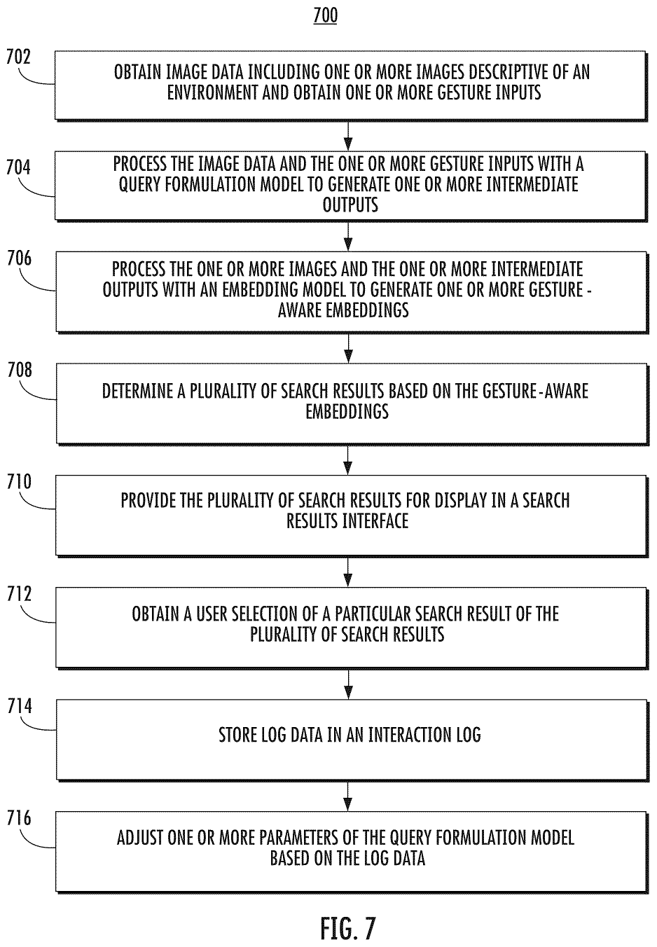

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain image data including one or more images descriptive of an environment and can obtain one or more gesture inputs. The one or more images can depict a camera feed of a user computing device and/or a livestream of a user computing device screen. The one or more gesture inputs can include one or more attributes. The one or more attributes can include one or more shapes, one or more sizes, and one or more positions associated with features within the one or more images. The one or more shapes may include a plurality of interconnected shapes. The one or more sizes may be scaled based on user interaction history, size of user computing device receiving the gesture inputs, and/or the size of the image features.

At 704, the computing system can process the image data and the one or more gesture inputs with a query formulation model to generate one or more intermediate outputs. The one or more intermediate outputs are descriptive of one or more regions determined to be associated with the one or more gesture inputs. The one or more intermediate outputs can be determined based on the features within the one or more images and the one or more attributes of the gesture inputs. In some implementations, the query formulation model can include a generative model trained on chain-of-thought reasoning training examples.

At 706, the computing system can process the one or more images and the one or more intermediate outputs with an embedding model to generate one or more gesture-aware embeddings. The query formulation model may be jointly trained with the embedding model. The one or more gesture-aware embeddings may include a plurality of vector representations.

At 708, the computing system can determine a plurality of search results based on the gesture-aware embeddings. The plurality of search results may be determined based on an embedding-based search performed with a search engine that identifies search results based on embedding distances within an embedding space and/or based on learned distributions.

At 710, the computing system can provide the plurality of search results for display in a search results interface. The plurality of search results may be provided for display with image tiles, text snippets, and/or links. The search results interface may include a model-generated response that is depicted with the plurality of search results. The model-generated response may be generated with a generative model that grounds the information of the response based on at least a subset of the plurality of search results.

At 712, the computing system can obtain a user selection of a particular search result of the plurality of search results. The user selection may cause the computing system to navigate the user computing device to a particular resource associated with the particular search result.

At 714, the computing system can store log data in an interaction log. The log data can include the one or more images, the one or more gesture inputs, the one or more intermediate outputs, the one or more search results, and data descriptive of the user selection. The log data may include metadata associated with a time of interaction, a time difference between display of search results and the selection, location of the user, and/or other context information.

At 716, the computing system can adjust one or more parameters of the query formulation model based on the log data. Adjusting the one or more parameters may include training the query formulation model based on a training triplet that includes the image data, the one or more gesture inputs, and the particular search result in which the parameters are tuned to generate intermediate outputs that indicate regions-of-interest determined to be associated with features of the particular search result.

In some implementations, the computing system can provide, within an interactive user interface, one or more region-of-interest visualizations of the one or more intermediate outputs overlaid over the one or more images, obtain one or more correction inputs descriptive of one or more augmentations to the one or more region-of-interest visualizations, evaluate one or more loss functions based on the one or more gesture inputs, the one or more intermediate outputs, and the one or more correction inputs, and adjust the one or more parameters of the query formulation model based on the one or more loss functions.

In some implementations, the query formulation model can be further trained on one or more pseudo labels generated with a generative language model. The one or more pseudo labels can be generated by obtaining one or more multimodal queries, processing the one or more multimodal queries with a generative language model to determine one or more requested tasks, generating, with the generative language model, one or more model-generated queries based on the one or more multimodal queries and the one or more requested tasks, and storing the one or more model-generated queries as the one or more pseudo labels. In some implementations, training with the one or more pseudo labels can include generating one or more refined queries based on the one or more images and the one or more intermediate outputs and adjusting the one or more parameters of the query formulation model based on a comparison between the one or more pseudo labels and the one or more refined queries.

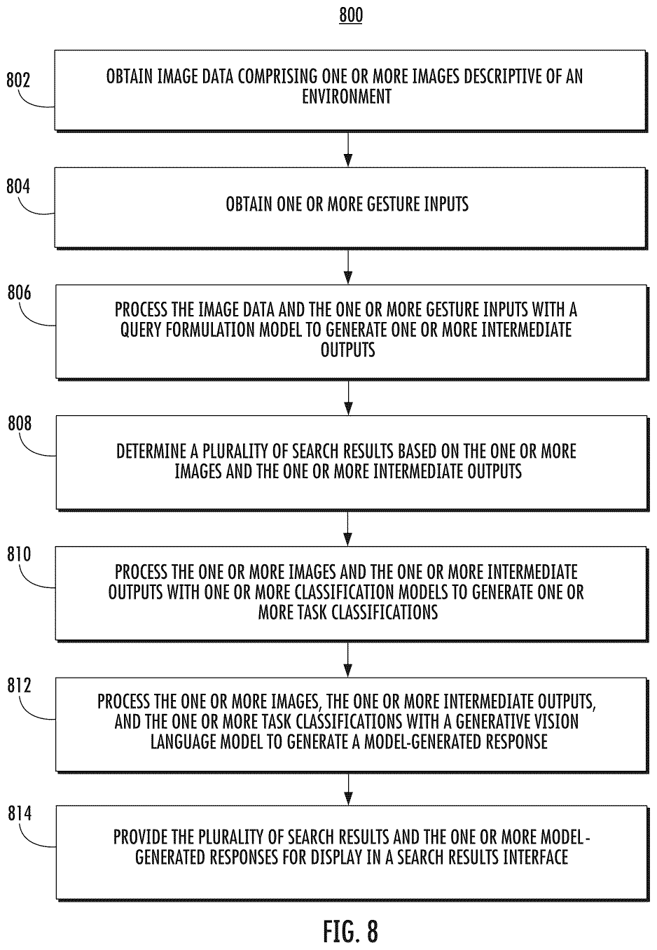

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain image data comprising one or more images descriptive of an environment. The image data can include the one or more images and image metadata. The environment can include a plurality of different features descriptive of a plurality of different objects. The one or more images may depict one or more screenshots of a user computing device. The image data may be generated with a mobile computing device, which may include a smart wearable (e.g., smart glasses).

At 804, the computing system can obtain one or more gesture inputs. The one or more gesture inputs can include one or more attributes. The one or more attributes can include one or more shapes, one or more sizes, and one or more positions associated with features within the one or more images. In some implementations, the one or more gesture inputs can include one or more irregular shapes. The one or more gesture inputs may be obtained via one or more sensors of a user computing device (e.g., sensors of a touchscreen). In some implementations, the one or more gesture inputs may be obtained via one or more sensors of a smart wearable (e.g., image sensors of smart glasses and/or touch sensors or motion sensors of a smart watch). The one or more shapes may include a plurality of interconnected shapes. The one or more sizes may be scaled based on user interaction history, size of user computing device receiving the gesture inputs, and/or the size of the image features.

At 806, the computing system can process the image data and the one or more gesture inputs with a query formulation model to generate one or more intermediate outputs. The one or more intermediate outputs can be descriptive of one or more regions determined to be associated with the one or more gesture inputs. The one or more intermediate outputs can be determined based on the features within the one or more images and the one or more attributes of the gesture inputs. In some implementations, the query formulation model may have been trained on log data from one or more interaction logs. The one or more interaction logs can include a plurality of training examples.

In some implementations, one or more of the plurality of training examples can include one or more logged images, one or more logged gesture inputs, one or more logged intermediate outputs descriptive of one or more regions determined to be associated with the one or more logged gesture inputs, and one or more logged correction inputs descriptive of one or more user corrections to the one or more logged intermediate outputs.

In some implementations, one or more of the plurality of training examples can include one or more logged images, one or more logged gesture inputs, one or more logged intermediate outputs descriptive of one or more regions determined to be associated with the one or more logged gesture inputs, one or more logged search results responsive to one or more queries comprising the one or more logged images and the one or more logged intermediate outputs, and one or more logged user selections of one or more of the one or more logged search results.

At 808, the computing system can determine a plurality of search results based on the one or more images and the one or more intermediate outputs. The plurality of search results may be determined based on processing the one or more images and the one or more intermediate outputs to generate one or more embeddings and determining a plurality of search result embeddings associated with the one or more embeddings. In some implementations, an image segment may be generated based on the intermediate output and the one or more images. The full one or more images and the image segment can then be processed with the search engine together to determine the plurality of search results.

At 810, the computing system can process the one or more images and the one or more intermediate outputs with one or more classification models to generate one or more task classifications. The one or more classification models may include one or more generative models (e.g., one or more large language models) fine-tuned to identify the particular task being requested. The one or more task classifications may be descriptive of the type of information requested and/or the level of detail requested.

At 812, the computing system can process the one or more images, the one or more intermediate outputs, and the one or more task classifications with a generative vision language model to generate a model-generated response. The model-generated response may include a natural language text string, an annotated image, multimodal data, and/or other data.

At 814, the computing system can provide the plurality of search results and the one or more model-generated responses for display in a search results interface. The search results interface may depict the model-generated response adjacent to the plurality of search results.

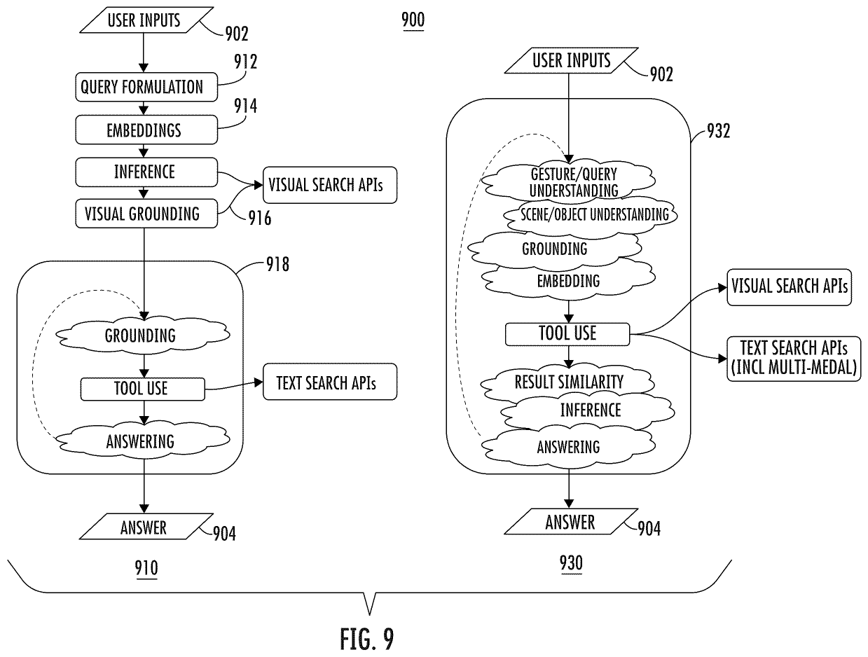

FIG. 9 depicts block diagrams of example search systems 900 according to example embodiments of the present disclosure. In particular, the query formulation model 912 can be implemented in a plurality of different search system configurations. FIG. 9 depicts two example search systems 900. The first search system 910 includes a plurality of separate data processing blocks. The second search system 930 includes an end-to-end integrated search system that fully-integrates the query formulation model within a larger artificial intelligence model. Both search systems 900 can receive a user input 902 (e.g., a query), which can be processed to generate an answer 904 to the user input 902.

The first search system 910 can obtain the user input 902. The user input 902 can be processed by a query formulation model 912 to generate a model-generated query (e.g., an image and an intermediate output that includes a fuzzy representation of the region-of-interest). The model-generated query can then be processed with an embedding model 914 to generate a query embedding. The query embedding can then be processed with an inference block and a visual grounding block 916 to perform one or more visual searches via one or more visual search APIs. The initial model inference and/or the visual search results can then be processed with a generative model 918 to determine and/or generate inference grounding based on the visual search results. One or more tool calls can then be performed (e.g., text search API calls) to obtain additional information for responding to the user input 902. The visual search results, initial inference, and/or the additional information can be transmitted to an answering head that can then determine whether a second set of additional information is necessitated. Once a threshold confidence is reached with resource grounding, the answer 904 can be generated with the generative model 918 (e.g., a large language model).

The second search system 930 can obtain the user input 902, can process the user input 902 with an end-to-end search-tuned generative model 932 to generate an answer 904, and can provide the answer 904 for display. The end-to-end search-tuned generative model 932 can include the query formulation model integrated as processing layers of the larger model. The query understanding of the query formulation model can be performed in series with and/or in parallel with scene and/or object detection and understanding. The end-to-end search-tuned generative model 932 can perform visual detail grounding. The end-to-end search-tuned generative model 932 may generate an embedding based on the outputs of the query formulation model, the outputs of the scene and/or object detection and understanding, and/or outputs of the grounding. The embedding can then be utilized to determine and/or perform tool calls for obtaining information based on the user input 902. The tool calls may include visual searches, text searches, and/or machine-learned model calls. The tool-obtained information can be processed to evaluate result relevance (e.g., result similarity). The vetted tool-obtained information can then be utilized to perform an inference on whether an answer of a threshold confidence can be generated. If the threshold has not been reached, another understanding-search-inference loop may be performed. Once a threshold is reached, the answer 904 can be generated and output.

The end-to-end search-tuned generative model 932 may include a vision language model. The end-to-end search-tuned generative model 932 may be agentic with a fully LLM-orchestrated reasoning loop that decides when to use tools, which visual objects and semantic concepts to analyze in more detail through retrieval or thinking steps rather than summarizing over a predefined definition of visual understanding. The end-to-end search-tuned generative model 932 may generate the answer 904 based on retrieval-augmented generation.

In some implementations, the systems and methods disclosed herein can utilize visual indicators to annotate images to provide visual grounding to a user, when processing and/or responding to a user query.

In some implementations, the systems and methods disclosed herein can perform task identification, which may then condition the query formulation model prediction.

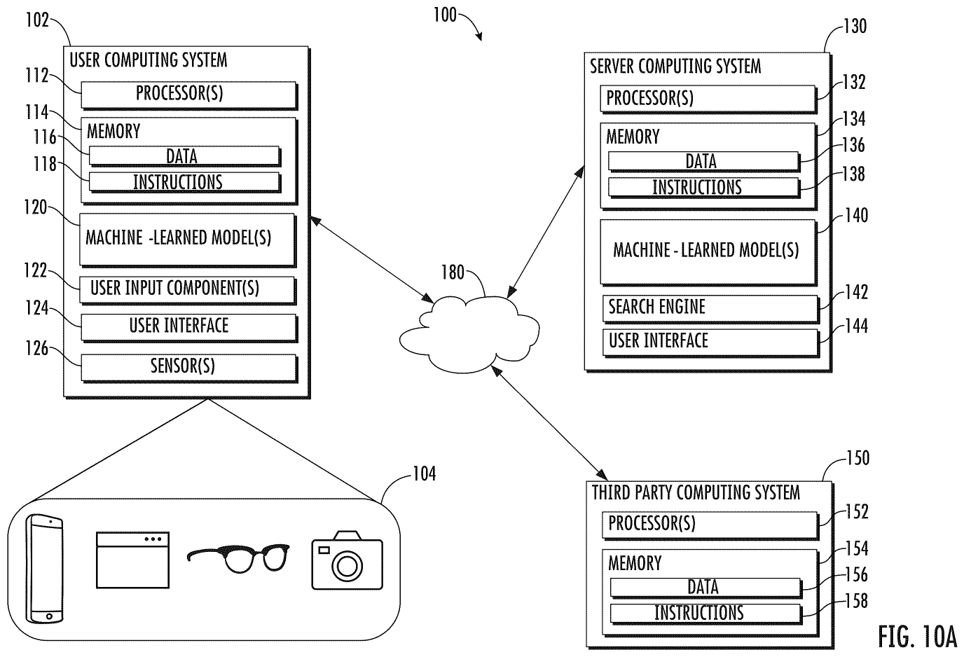

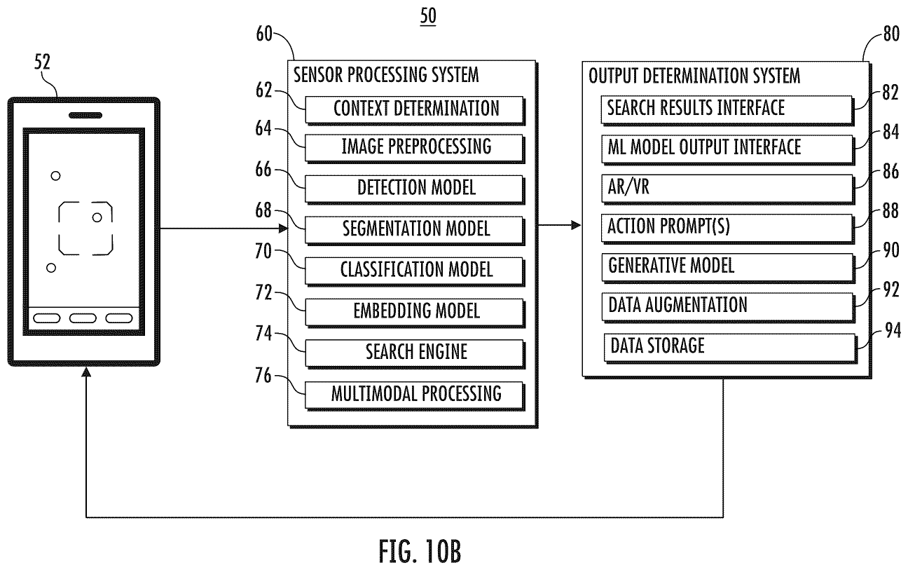

FIG. 10A depicts a block diagram of an example computing system 100 that performs query formulation model training and inference according to example embodiments of the present disclosure. The system 100 includes a user computing system 102, a server computing system 130, and/or a third party computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention.

For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 102 can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 10B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 100 may utilize one or more soft prompts for conditioning the one or more machine-learned models (120 and/or 140) for downstream tasks. The one or more soft prompts can include a set of tunable parameters that can be trained (or tuned) as the parameters of the one or more machine-learned models (120 and/or 140) are fixed. The one or more soft prompts 124 can be trained for a specific task and/or a specific set of tasks. Alternatively and/or additionally, the one or more soft prompts 124 may be trained to condition the one or more machine-learned models (120 and/or 140) to perform inferences for a particular individual, one or more entities, and/or one or more tasks such that the output is tailored for that particular individual, particular entities, and/or particular task. The one or more soft prompts 124 can be obtained and processed with one or more inputs by the one or more machine-learned models (120 and/or 140).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 100 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 102 and/or the server computing system 130 may store one or more soft prompts associated with the particular user and/or particular task. The soft prompt(s) can include a set of parameters. The user computing system 102 and/or the server computing system 130 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 130 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 120 and/or 140) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc.

Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 100.

The central intelligence layer can communicate with a central device data layer. The central device data layer can be a centralized repository of data for the computing system 100.

The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 10B depicts a block diagram of an example computing system 50 that performs query formulation model training and inference according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlaid over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment.

Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 90 may be stored on-device and/or may be stored on a server computing system. In some implementations, the one or more generative models 90 can perform on-device processing to determine suggested searches, suggested actions, and/or suggested prompts. The one or more generative models 90 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 90 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence.

The system can generate outputs based on output sequence.

Sequence processing models can include one or multiple machine-learned model components configured to ingest, generate, or otherwise reason over sequences of information.

For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (October 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ______.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv:2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method, the method comprising:
obtaining, by a computing system comprising one or more processors, image data comprising one or more images descriptive of an environment;
obtaining, by the computing system, one or more gesture inputs, wherein the one or more gesture inputs comprise one or more attributes, wherein the one or more attributes comprise one or more shapes, one or more sizes, and one or more positions associated with features within the one or more images, wherein the one or more gesture inputs comprise one or more freeform inputs;
processing, by the computing system, the image data and the one or more gesture inputs with a query formulation model to generate one or more intermediate outputs, wherein the one or more intermediate outputs are descriptive of one or more regions determined to be associated with the one or more gesture inputs, wherein the one or more intermediate outputs are determined based on the features within the one or more images and the one or more attributes of the gesture inputs;
providing, by the computing system and within an interactive user interface, one or more region-of-interest visualizations of the one or more intermediate outputs overlaid over the one or more images;
obtaining, by the computing system, one or more correction inputs descriptive of one or more augmentations to the one or more region-of-interest visualizations, wherein the one or more correction inputs are descriptive of a correction of a region-of-interest associated with the image data and the one or more gesture inputs, and wherein the one or more correction inputs are descriptive of one or more user corrections to the one or more intermediate outputs;
evaluating, by the computing system, one or more loss functions based on the one or more gesture inputs, the one or more intermediate outputs, and the one or more correction inputs; and
adjusting, by the computing system, one or more parameters of the query formulation model based on the one or more loss functions.

2. The method of claim 1, further comprising:
processing, by the computing system, the one or more images and the one or more intermediate outputs with an embedding model to generate one or more gesture-aware embeddings; and
determining, by the computing system, one or more search results based on the gesture-aware embeddings.

3. The method of claim 2, further comprising:
processing, by the computing system, the one or more images, the one or more intermediate outputs, and the one or more search results with a generative model to generate one or more model-generated responses to the query.

4. The method of claim 3, wherein the generative model comprises a vision language model, and wherein the one or more model-generated responses comprise a plurality of predictions grounded based on information of the one or more search results.

5. The method of claim 3, wherein the one or more model-generated responses comprises one or more multimodal responses to the query.

6. The method of claim 2, further comprising:
providing, by the computing system, the one or more search results for display in a search results interface;
obtaining, by the computing system, a user selection of a particular search result of the one or more search results; and
storing, by the computing system, log data in an interaction log, wherein the log data comprises the one or more images, the one or more gesture inputs, the one or more intermediate outputs, the one or more search results, and data descriptive of the user selection.

7. The method of claim 6, further comprising:
adjusting, by the computing system, the one or more parameters of the query formulation model based on the log data.

8. The method of claim 1, wherein the one or more gesture inputs comprises one or more irregular shapes.

9. The method of claim 1, wherein the one or more intermediate outputs comprise a plurality of pixel-based positional values descriptive of one or more boundaries of one or more regions of interest.

10. The method of claim 1, wherein the one or more intermediate outputs comprise one or more attention maps.

11. A computing system for query formulation model training, the system comprising:
one or more processors; and
one or more non-transitory computer-readable media that collectively store instructions that, when executed by the one or more processors, cause the computing system to perform operations, the operations comprising:
obtaining image data comprising one or more images descriptive of an environment;
obtaining one or more gesture inputs, wherein the one or more gesture inputs comprise one or more attributes, wherein the one or more attributes comprise one or more shapes, one or more sizes, and one or more positions associated with features within the one or more images;
processing the image data and the one or more gesture inputs with a query formulation model to generate one or more intermediate outputs, wherein the one or more intermediate outputs are descriptive of one or more regions determined to be associated with the one or more gesture inputs, wherein the one or more intermediate outputs are determined based on the features within the one or more images and the one or more attributes of the gesture inputs, wherein the query formulation model comprises a generative model trained on chain-of-thought reasoning training examples, and wherein the generative model is trained to be agentic to perform orchestrated reasoning loops to decide when to use external tools;
processing the one or more images and the one or more intermediate outputs with an embedding model to generate one or more gesture-aware embeddings;
determining a plurality of search results based on the gesture-aware embeddings;
providing the plurality of search results for display in a search results interface;
obtaining a user selection of a particular search result of the plurality of search results;
storing log data in an interaction log, wherein the log data comprises the one or more images, the one or more gesture inputs, the one or more intermediate outputs, the one or more search results, and data descriptive of the user selection, and
adjusting one or more parameters of the query formulation model based on the log data.

12. The system of claim 11, wherein the operations further comprise:
providing, within an interactive user interface, one or more region-of-interest visualizations of the one or more intermediate outputs overlaid over the one or more images;
obtaining one or more correction inputs descriptive of one or more augmentations to the one or more region-of-interest visualizations;
evaluating one or more loss functions based on the one or more gesture inputs, the one or more intermediate outputs, and the one or more correction inputs; and
adjusting the one or more parameters of the query formulation model based on the one or more loss functions.

13. The system of claim 11, wherein the query formulation model is further trained on one or more pseudo labels generated with a generative language model.

14. The system of claim 13, wherein the one or more pseudo labels are generated by:
obtaining one or more multimodal queries;
processing the one or more multimodal queries with a generative language model to determine one or more requested tasks;
generating, with the generative language model, one or more model-generated queries based on the one or more multimodal queries and the one or more requested tasks; and
storing the one or more model-generated queries as the one or more pseudo labels.

15. The system of claim 13, wherein training with the one or more pseudo labels comprises:
generating one or more refined queries based on the one or more images and the one or more intermediate outputs; and
adjusting the one or more parameters of the query formulation model based on a comparison between the one or more pseudo labels and the one or more refined queries.

16. (canceled)

17. One or more non-transitory computer-readable media that collectively store instructions that, when executed by one or more computing devices, cause the one or more computing devices to perform operations, the operations comprising:
obtaining image data comprising one or more images descriptive of an environment;
obtaining one or more gesture inputs, wherein the one or more gesture inputs comprise one or more attributes, wherein the one or more attributes comprise one or more shapes, one or more sizes, and one or more positions associated with features within the one or more images;
processing the image data and the one or more gesture inputs with a query formulation model to generate one or more intermediate outputs, wherein the one or more intermediate outputs are descriptive of one or more regions determined to be associated with the one or more gesture inputs, wherein the one or more intermediate outputs are determined based on the features within the one or more images and the one or more attributes of the gesture inputs;
determining a plurality of search results based on the one or more images and the one or more intermediate outputs;
processing the one or more images and the one or more intermediate outputs with one or more classification models to generate one or more task classifications;
processing the one or more images, the one or more intermediate outputs, and the one or more task classifications with a generative vision language model to generate a model-generated response; and
providing the plurality of search results and the one or more model-generated responses for display in a search results interface.

18. The one or more non-transitory computer-readable media of claim 17, wherein the query formulation model was trained on log data from one or more interaction logs, wherein the one or more interaction logs comprise a plurality of training examples.

19. The one or more non-transitory computer-readable media of claim 18, wherein one or more of the plurality of training examples comprise:
one or more logged images;
one or more logged gesture inputs;
one or more logged intermediate outputs descriptive of one or more regions determined to be associated with the one or more logged gesture inputs; and
one or more logged correction inputs descriptive of one or more user corrections to the one or more logged intermediate outputs.

20. The one or more non-transitory computer-readable media of claim 18, wherein one or more of the plurality of training examples comprise:
one or more logged images;
one or more logged gesture inputs;
one or more logged intermediate outputs descriptive of one or more regions determined to be associated with the one or more logged gesture inputs;
one or more logged search results responsive to one or more queries comprising the one or more logged images and the one or more logged intermediate outputs; and
one or more logged user selections of one or more of the one or more logged search results.
